(19) United States
(12) Patent Application Publication
(10) Pub. No.: US 2026/0220925 A1
(43) Pub. Date: Jul. 30, 2026

(54) INFORMATION PROCESSING METHOD, INFORMATION PROCESSING DEVICE, AND PROGRAM

(71) Applicant: PANASONIC INTELLECTUAL PROPERTY MANAGEMENT CO., LTD., Osaka (JP)

(72) Inventors: Yuya SUGASAWA, Osaka (JP); Hisaji MURATA, Osaka (JP)

(73) Assignee: PANASONIC INTELLECTUAL PROPERTY MANAGEMENT CO., LTD., Osaka (JP)

(21) Appl. No.: 19/148,800

(22) PCT Filed: Dec. 12, 2023
(86) PCT No.: PCT/JP2023/044334

§ 371 Date: Jul. 17, 2025

(30) Foreign Application Priority Data
Jan. 24, 2023 (JP) 2023-008938

(51) Int. Cl. G06V 10/776; G06V 10/774

(52) U.S. Cl. CPC G06V 10/776; G06V 10/774

(57) ABSTRACT

An information processing device identifies at least one change factor between a predetermined reference data set and a verification data set different from the reference data set based on the reference data set and the verification data set; generates and outputs explanatory information for presenting the identified change factor to a user; and performs the relearning of the machine learning model based on policy information indicating a policy for the relearning set by the user based on the explanatory information.

### TECHNICAL FIELD

The present disclosure relates to an information processing method, an information processing device, and a program.

### BACKGROUND ART

Patent Literature 1 discloses, when accuracy of predicted values output from a black-box machine learning model deteriorates, an analysis system that allows identification of a factor of the deterioration. A white-box model creation unit creates a white-box model by using input data used in the creation of the black-box model as an explanatory variable, and the predicted values output by the black-box model as an objective variable. An accuracy deterioration factor identifying unit identifies a factor that causes a change in the accuracy of the predicted values by inputting accumulated input data during a predetermined determination period into the white-box model when the accuracy of the predicted values output by the black-box model has deteriorated during the determination period.

However, in the analysis system disclosed in Patent Literature 1, it is necessary to create a high-accuracy white-box model having a level that can be used to analyze the factor of the accuracy deterioration of the black-box model, and creating such a high-accuracy white-box model is difficult.

### CITATION LIST

### Patent Literature

Patent Literature 1: Japanese Patent No. 6899475

### SUMMARY OF INVENTION

An object of the present disclosure is to provide an information processing method, an information processing device, and a program that can efficiently assist relearning of a machine learning model by a user.

An information processing method according to one aspect of the present disclosure is an information processing method for assisting relearning of a machine learning model, the method including: by an information processing device, identifying at least one change factor between a predetermined reference data set and a verification data set different from the reference data set based on the reference data set and the verification data set; generating and outputting explanatory information for presenting the identified change factor to a user; and performing the relearning of the machine learning model based on policy information indicating a policy for the relearning set by the user based on the explanatory information.

### Advantages of the Invention

According to the present disclosure, it is possible to efficiently assist relearning of the machine learning model by the user.

### BRIEF DESCRIPTION OF DRAWINGS

FIG. 1 is a diagram showing a configuration of a relearning assistance device according to an embodiment of the present disclosure.

FIG. 2 is a flowchart showing the flow of processing executed by an information processing unit.

FIG. 3 is a flowchart showing one example of processing of identifying a change factor.

FIG. 4 is a diagram showing an input screen as a first example of explanatory information.

FIG. 5 is a diagram showing an input screen as a second example of the explanatory information.

FIG. 6 is a diagram showing an input screen as a third example of the explanatory information.

### DESCRIPTION OF EMBODIMENTS

### (Knowledge Underlying Present Disclosure)

After introducing an image recognition AI system that recognizes the type of an input image or the like using a learned machine learning model, there may be an increase in incorrect determination due to data set shift. The data set shift includes concept drift, where the very concept of a correct label changes over time, and data drift, where the statistical distribution of data changes over time.

In the current image recognition AI system, when performing relearning of the machine learning model due to a decrease in determination accuracy caused by the data set shift, the analysis of the determination image and modification of learning data are performed manually by a user on an image-by-image basis, making the efficiency of the relearning poor.

To solve this problem, the present inventors have conceived the present disclosure by obtaining the knowledge that the efficiency of relearning can be improved by receiving and transmitting higher-order information (analysis and adaptation based on explanations) rather than on an image-by-image basis.

Next, each aspect of the present disclosure will be described.

An information processing method according to a first aspect of the present disclosure is an information processing method for assisting relearning of a machine learning model, the method including: by an information processing device, identifying at least one change factor between a predetermined reference data set and a verification data set different from the reference data set based on the reference data set and the verification data set; generating and outputting explanatory information for presenting the identified change factor to a user; and performing the relearning of the machine learning model based on policy information indicating a policy for the relearning set by the user based on the explanatory information.

According to the first aspect, the explanatory information indicating the identified change factor is presented to the user, and the relearning of the machine learning model is performed based on the policy information set by the user based on the explanatory information. In this way, the relearning is performed by exchanging the explanatory information and the policy information, rather than by the user's manual operation on an image-by-image basis, making it possible to efficiently assist relearning of the machine learning model by the user.

In the information processing method according to a second aspect of the present disclosure, preferably, the explanatory information includes a reference image representing a representative image obtained by visualizing the reference data set, and a verification image representing a representative image obtained by visualizing the verification data set in the first aspect.

The second aspect allows presentation of the explanatory information including the reference image and the verification image to the user, making it possible to more efficiently assist relearning of the machine learning model by the user.

In the information processing method according to a third aspect of the present disclosure, preferably, the at least one change factor includes a plurality of the change factors, and generating the explanatory information includes individually generating the reference image and the verification image for each of the plurality of change factors in the second aspect.

According to the third aspect, the explanatory information including the reference image and the verification image generated individually for each of the plurality of change factors can be presented to the user, and the user can easily understand the change form of the change factor, making it possible to more efficiently assist relearning of the machine learning model by the user.

In the information processing method according to a fourth aspect of the present disclosure, preferably, the explanatory information further includes an index value of the change factor regarding the reference image and an index value of the change factor regarding the verification image in the second aspect.

According to the fourth aspect, the explanatory information including the index values of the change factors for each of the reference image and the verification image can be presented to the user, and the user can easily understand the change form of the change factors, making it possible to more efficiently assist relearning of the machine learning model by the user.

In the information processing method according to a fifth aspect of the present disclosure, preferably, the explanatory information further includes at least one of a correction image that reflects a change form of the change factor in one of the reference image and the verification image, and a difference image between the reference image and the verification image in the second aspect.

According to the fifth aspect, the explanatory information including at least one of the correction image and the difference image can be presented to the user, and the user can easily understand the change form of the change factor, making it possible to more efficiently assist relearning of the machine learning model by the user.

In the information processing method according to a sixth aspect of the present disclosure, preferably, the at least one change factor includes a plurality of the change factors, and the policy information includes setting information set by the user regarding whether or not each of the plurality of change factors is to be a subject of the relearning in any one of the first to fifth aspects.

According to the sixth aspect, the user can set whether or not each of the plurality of change factors is to be a subject of relearning with the setting information, making it possible to more efficiently assist relearning of the machine learning model by the user.

In the information processing method according to a seventh aspect of the present disclosure, preferably, the policy information further includes setting information set by the user as to a permissible range during the relearning regarding the change factor that is a subject of the relearning in the sixth aspect.

According to the seventh aspect, the user can set the permissible range during the relearning with the setting information, making it possible to more efficiently assist relearning of the machine learning model by the user.

In the information processing method according to an cighth aspect of the present disclosure, preferably, identifying the change factor includes identifying the change factor based on an output value when the reference data set is input to a predetermined learned model and an output value when the verification data set is input to the learned model in any one the first to seventh aspects.

According to the eighth aspect, the change factor is identified based on the output value when the reference data set is input to the learned model and the output value when the verification data set is input to the learned model, making it possible to easily identify the change factor between the reference data set and the verification data set. Even when changes in features that are difficult to quantify occur, using the learned model makes it possible to identify the change factor between the reference data set and the verification data set by using higher-level feature amounts.

In the information processing method according to a ninth aspect of the present disclosure, preferably, as the learned model, the machine learning model that is a subject of the relearning is used in the eighth aspect.

According to the ninth aspect, using the machine learning model, which is a subject of relearning, as the learned model makes it possible to easily and accurately identify the change factor between the reference data set and the verification data set.

In the information processing method according to a tenth aspect of the present disclosure, preferably, the reference data set includes learning image data used when learning the machine learning model, and the verification data set includes verification image data that is incorrectly determined in inference using the learned machine learning model in the ninth aspect.

According to the tenth aspect, the reference data set includes the learning image data used when learning the machine learning model, and the verification data set includes the verification image data that is incorrectly determined in inference using the machine learning model, making it possible to easily and accurately identify the change factor between the reference data set and the verification data set.

In the information processing method according to an eleventh aspect of the present disclosure, preferably, in identifying the change factor, when determination accuracy is improved by performing image processing in a first direction on the verification image data, performing the relearning of the machine learning model includes performing the relearning by using image data obtained by performing image processing in a second direction opposite to the first direction on the learning image data in the tenth aspect.

According to the eleventh aspect, when the determination accuracy is improved by performing image processing in the first direction on the verification image data, performing relearning using image data obtained by performing the image processing in the second direction opposite to the first direction on the learning image data makes it possible to improve the determination accuracy of the machine learning model after the relearning.

An information processing device according to a twelfth aspect of the present disclosure is an information processing device for assisting relearning of a machine learning model, and includes: an identifying unit that identifies at least one change factor between a predetermined reference data set and a verification data set different from the reference data set based on the reference data set and the verification data set; a generation unit that generates and outputs explanatory information for presenting the change factor identified by the identifying unit to a user; and a relearning unit that performs the relearning of the machine learning model based on policy information indicating a policy for the relearning set by the user based on the explanatory information.

According to the twelfth aspect, the explanatory information indicating the identified change factor is presented to the user, and relearning of the machine learning model is performed based on the policy information set by the user based on the explanatory information. In this way, the relearning is performed by exchanging the explanatory information and the policy information, rather than by the user's manual operation on an image-by-image basis, making it possible to efficiently assist relearning of the machine learning model by the user.

A program according to a thirteenth aspect of the present disclosure is a program for causing an information processing device for assisting relearning of a machine learning model to function as: identifying means that identifies at least one change factor between a predetermined reference data set and a verification data set different from the reference data set based on the reference data set and the verification data set; generation means that generates and outputs explanatory information for presenting the change factor identified by the identifying means to a user; and relearning means that performs the relearning of the machine learning model based on policy information indicating a policy for the relearning set by the user based on the explanatory information.

According to the thirteenth aspect, the explanatory information indicating the identified change factor is presented to the user, and relearning of the machine learning model is performed based on the policy information set by the user based on the explanatory information. In this way, the relearning is performed by exchanging the explanatory information and the policy information, rather than by the user's manual operation on an image-by-image basis, making it possible to efficiently assist relearning of the machine learning model by the user.

The present disclosure can also implement each characteristic configuration included in such a method or device as a program to be executed by a computer or as a system operated by this program. It is needless to say that such a computer program can be distributed via a computer-readable non-transitory recording medium such as a CD-ROM or via a communication network such as the Internet.

### Embodiments of Present Disclosure

Embodiments of the present disclosure will be described below in detail with reference to the drawings. Elements denoted with the same reference symbol in different drawings represent the same or corresponding elements. Components, placement positions of the components, connection forms, the order of operations, and the like shown in the following embodiments are one example, and are not intended to limit the present disclosure. The present disclosure is limited only by the claims. Therefore, a component that is not described in an independent claim indicating the most generic concept of the present disclosure among components in the following embodiments is not necessarily required to achieve the object of the present disclosure, but the component is described as constituting a more preferable form.

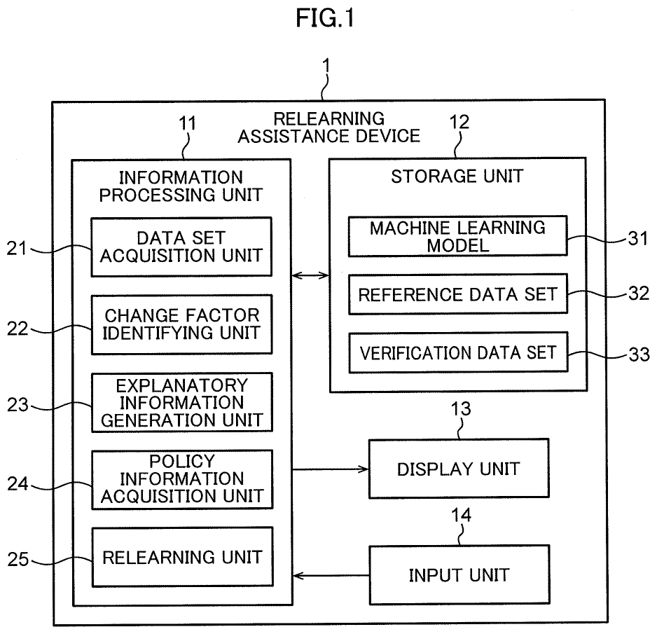

FIG. 1 is a diagram showing a configuration of a relearning assistance device 1 according to an embodiment of the present disclosure. The relearning assistance device 1 is a device designed to assist the user in the relearning of the learned machine learning model 31. The relearning assistance device 1 may be a dedicated terminal, a general-purpose computer, or the like, or a server device such as a cloud server or an edge server.

The relearning assistance device 1 includes an information processing unit 11, a storage unit 12, a display unit 13, and an input unit 14. The information processing unit 11 is configured using a processor (information processing device) such as a CPU or GPU. The storage unit 12 is configured using an HDD, an SSD, a semiconductor memory, or the like. The display unit 13 is configured using a liquid crystal display, an organic EL display, or the like. The input unit 14 is configured using a keyboard, a mouse, or the like.

The storage unit 12 stores the machine learning model 31, a reference data set 32, and a verification data set 33. The machine learning model 31 includes a learned machine learning model, which is a subject of relearning. The reference data set 32 includes learning image data used for learning of the machine learning model 31. The verification data set 33 includes verification image data that is incorrectly determined in inference using the learned machine learning model 31. Note that the learning image data and the verification image data may be image data including distance information, such as image data acquired using LiDAR. Instead of the above image data, the reference data set 32 and the verification data set 33 may be sensing data output from various sensors that detect current, vibration, acoustic emission, or the like, or may be voice data or the like output from a microphone that collects the user's voice. In the present embodiment, an example will be described in which the reference data set 32 and the verification data set 33 contain image data.

As functions implemented by a processor executing a program read from a nonvolatile recording medium such as a computer-readable ROM, the information processing unit 11 includes a data set acquisition unit 21, a change factor identifying unit 22, an explanatory information generation unit 23, a policy information acquisition unit 24, and a relearning unit 25. In other words, the above program is a program that causes the information processing unit 11 as an information processing device mounted in the relearning assistance device 1 for assisting the relearning of the machine learning model 31 to function as the data set acquisition unit 21 (data set acquisition means), the change factor identifying unit 22 (change factor identifying means), the explanatory information generation unit 23 (explanatory information generation means), the policy information acquisition unit 24 (policy information acquisition means), and the relearning unit 25 (relearning means).

The data set acquisition unit 21 acquires the reference data set 32 and the verification data set 33 by reading the data from the storage unit 12.

Based on the reference data set 32 and the verification data set 33 acquired by the data set acquisition unit 21, the change factor identifying unit 22 identifies at least one change factor between the reference data set 32 and the verification data set 33. The change factor identifying unit 22 identifies the change factor based on a difference between an output value when the reference data set 32 is input to a predetermined learned model and an output value when the verification data set 33 is input to the same learned model. The learned model is a model learned in the same domain as the reference data set 32 and the verification data set 33. The learned model may be the same model as the machine learning model 31, which is a subject of relearning, or may be a different model. In the present embodiment, the same model is preferable for accuracy improvement. When learning and relearning of the machine learning model 31 are performed using a neural network having an input layer, an intermediate layer, and an output layer, the output value may be an output value from the output layer of the neural network, or may be an output value from the intermediate layer during processing.

The explanatory information generation unit 23 generates and outputs explanatory information for presenting the change factor identified by the change factor identifying unit 22 to the user. The explanatory information includes input screens 41 to 43, which are displayed on the display unit 13 and will be described later. The explanatory information includes a reference image 51 representing a representative image obtained by visualizing the reference data set 32, and a verification image 61 representing a representative image obtained by visualizing the verification data set 33.

The policy information acquisition unit 24 acquires, from the input unit 14, policy information indicating a relearning policy set by the user based on the explanatory information. As will be described in detail later, the policy information includes setting information set by the user regarding whether or not each of a plurality of change factors is to be a subject of relearning. In addition, the policy information includes setting information set by the user as to a permissible range during relearning regarding the change factor that is a subject of relearning.

The relearning unit 25 performs relearning of the machine learning model 31 based on the policy information acquired by the policy information acquisition unit 24.

Note that the data set acquisition unit 21, the change factor identifying unit 22, the explanatory information generation unit 23, the policy information acquisition unit 24, and the relearning unit 25 may be implemented by a single information processing device or may be implemented by a plurality of information processing devices. The machine learning model 31, the reference data set 32, and the verification data set 33 may be stored in a single storage medium, or may be stored in a plurality of storage media.

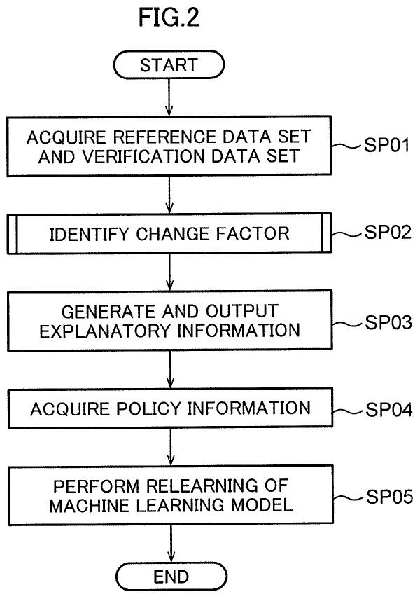

FIG. 2 is a flowchart showing the flow of processing executed by the information processing unit 11.

First, in step SP01, the data set acquisition unit 21 acquires the reference data set 32 and the verification data set 33 by reading the data sets from the storage unit 12.

Next, in step SP02, based on a difference between the reference data set 32 and the verification data set 33 acquired by the data set acquisition unit 21 in step SP01, the change factor identifying unit 22 identifies at least one change factor between the reference data set 32 and the verification data set 33.

Next, in step SP03, the explanatory information generation unit 23 generates and outputs the explanatory information for presenting the change factor identified by the change factor identifying unit 22 in step SP02 to the user. The explanatory information is displayed on the display unit 13 as input screens 41 to 43, which will be described later.

Next, in step SP04, based on the explanatory information output in step SP03, the policy information acquisition unit 24 acquires, from the input unit 14, the policy information indicating the relearning policy set by the user.

Next, in step SP05, based on the policy information acquired by the policy information acquisition unit 24 in step SP04, the relearning unit 25 performs relearning of the machine learning model 31.

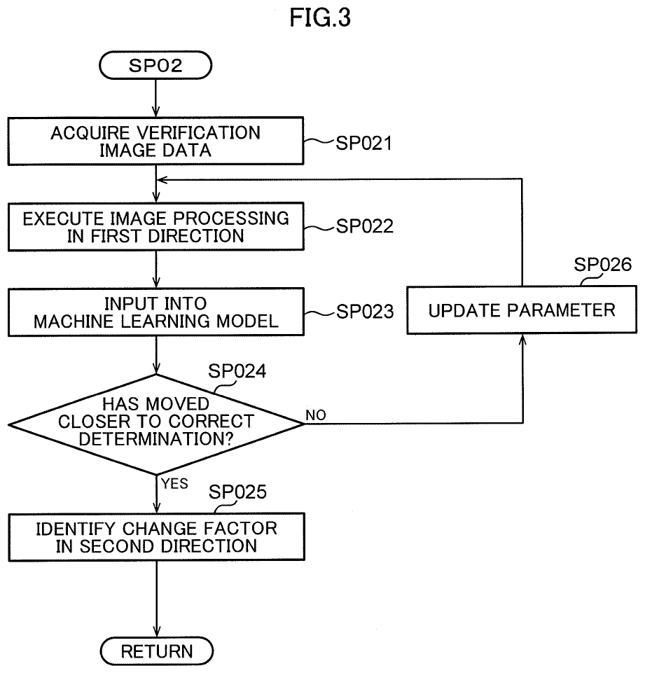

FIG. 3 is a flowchart showing one example of processing for identifying the change factor (step SP02).

First, in step SP021, the change factor identifying unit 22 acquires the verification image data that is incorrectly determined in inference using the learned machine learning model 31.

Next, in step SP022, the change factor identifying unit 22 executes image processing in a first direction on the verification image data acquired in step SP021. When the change factor to be analyzed is, for example, luminance, the change factor identifying unit 22 executes image processing for increasing the luminance of the verification image data as the image processing in the first direction.

Next, in step SP023, the change factor identifying unit 22 inputs the verification image data obtained by executing the image processing in the first direction in step SP022 into the machine learning model 31, which is a subject of relearning.

Next, in step SP024, the change factor identifying unit 22 confirms whether the determination accuracy of the machine learning model 31 has improved by the execution of step SP023. That is, it is confirmed whether the verification image data that is incorrectly determined before the execution of step SP023 has moved closer to correct determination after the execution of step SP023. For example, regarding image data where defects are missed before the execution of the image processing, if the probability of defect determination increases after the execution of the image processing, the change factor identifying unit 22 determines that the verification image data has moved closer to correct determination by the image processing. Alternatively, if the output of the intermediate layer when the image data where defects are missed before the execution of the image processing is inferred by the machine learning model 31 after the execution of the image processing is plotted near the output of the intermediate layer of the learning data with a defect label, the change factor identifying unit 22 may determine that the verification image data has moved closer to correct determination by the image processing. Whether or not the output is plotted near the output of the intermediate layer of the learning data with a defect label can be quantitatively evaluated based on the proportion of the learning data with a defect label among the plurality of nearby data.

When the verification image data has moved closer to correct determination (step SP024: YES), next in step SP025, the change factor identifying unit 22 identifies the change factor in a second direction opposite to the first direction as a change factor between the reference data set 32 and the verification data set 33. For example, when image processing for increasing luminance of the verification image data is executed as the image processing in the first direction, a change factor of a decrease in luminance is identified as the change factor between the reference data set 32 and the verification data set 33. In this case, in step SP05, the relearning unit 25 adds image data obtained by performing the image processing in the second direction on the learning image data to the reference data set 32, and performs relearning of the machine learning model 31.

On the other hand, when the verification image data has not moved closer to correct determination (step SP024: NO), next in step SP026, the change factor identifying unit 22 updates the parameter to be analyzed, and repeats the processing from step SP022 onward on the parameter after the update. For example, when all the parameters to be analyzed are luminance, contrast, noise amount, and size, and the parameter before the update is luminance, the change factor identifying unit 22 updates the parameter to be analyzed from luminance to contrast. The change factor identifying unit 22 repeats the parameter update until the processing for all the parameters to be analyzed is completed.

The change factor identifying unit 22 may use statistical information on the reference data set 32 and the verification data set 33 as the difference between the reference data set 32 and the verification data set 33. The relearning unit 25 may select image processing associated with the statistical information having the difference, and use the selected image processing to perform data augmentation when performing relearning of the machine learning model 31. When the statistical information used by the change factor identifying unit 22 is a statistical quantity of luminance or contrast of the entire image or the image recognition subject, the image processing selected by the relearning unit 25 is the luminance change or contrast change. Alternatively, when the statistical information used by the change factor identifying unit 22 is a statistical quantity of a ratio of a length measurement result of a predetermined portion of the image recognition subject or a length measurement result of a plurality of portions, the image processing selected by the relearning unit 25 is affine transformation of the image.

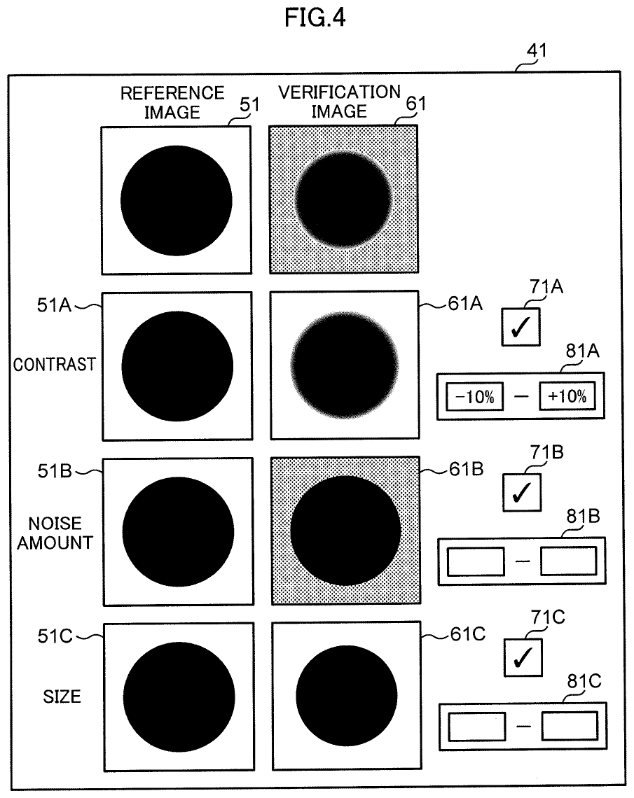

FIG. 4 is a diagram showing an input screen 41 as a first example of the explanatory information generated by the explanatory information generation unit 23. The input screen 41 is presented to the user by being displayed on the display unit 13. FIG. 4 shows an example where a plurality of change factors (contrast, noise amount, and size) is identified by the change factor identifying unit 22.

The input screen 41 includes the reference image 51 representing a representative image obtained by visualizing the reference data set 32, and the verification image 61 representing a representative image obtained by visualizing the verification data set 33. The representative image is an average image, a median image, a centroid image, or the like regarding a plurality of images included in each data set. The verification image 61 reflects all of the change factors of contrast, noise amount, and size. In the example shown in FIG. 4, the verification image 61 is obtained as an image in which the contrast of the subject has decreased, the noise amount has increased, and the size has decreased, compared to the reference image 51.

The input screen 41 includes reference images 51A to 51C generated individually for each of the plurality of change factors, and verification images 61A to 61C generated individually for each of the plurality of change factors. The verification image 61A that reflects the change factor of the contrast but does not reflect the change factor of the noise amount and size is displayed next to the reference image 51A that is similar to the reference image 51. The verification image 61B that reflects the change factor of the noise amount but does not reflect the change factor of the contrast and size is displayed next to the reference image 51B that is similar to the reference image 51. The verification image 61C that reflects the change factor of the size but does not reflect the change factor of the contrast and noise amount is displayed next to the reference image 51C that is similar to the reference image 51.

The input screen 41 includes selection information input fields 71A to 71C for the user to select whether or not each of the plurality of change factors should be included as a subject of relearning. When selecting to include the contrast as a subject of relearning, the user operates the input unit 14 to input a check mark to the selection information input field 71A. When selecting to include the noise amount as a subject of relearning, the user operates the input unit 14 to input a check mark to the selection information input field 71B. When selecting to include the size as a subject of relearning, the user operates the input unit 14 to input a check mark to the selection information input field 71C.

The input screen 41 includes numerical information input fields 81A to 81C for the user to input numerical information regarding the permissible range when performing relearning for each of the plurality of change factors. When including the contrast as a subject of relearning and setting the permissible range for the contrast, the user operates the input unit 14 to input at least one of the lower limit and the upper limit into the numerical information input field 81A. When including the noise amount as a subject of relearning and setting the permissible range for the noise amount, the user operates the input unit 14 to input at least one of the lower limit and the upper limit into the numerical information input field 81B. When including the size as a subject of relearning and setting the permissible range for the size, the user operates the input unit 14 to input at least one of the lower limit and the upper limit into the numerical information input field 81C.

The contents input by the user into the selection information input fields 71A to 71C and the numerical information input fields 81A to 81C in the input screen 41 are input to the information processing unit 11 as the policy information indicating the policy set by the user for relearning, and are acquired by the policy information acquisition unit 24.

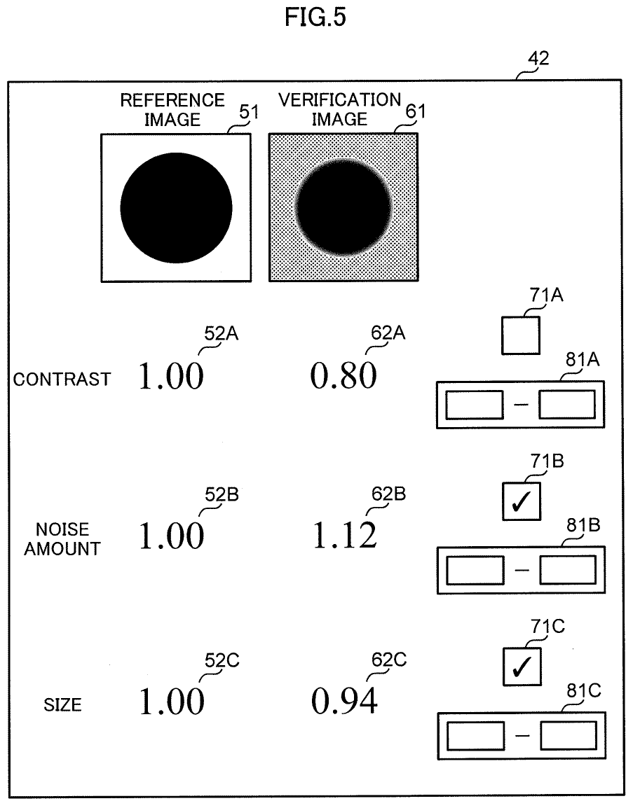

FIG. 5 is a diagram showing an input screen 42 as a second example of the explanatory information generated by the explanatory information generation unit 23. The input screen 42 is presented to the user by being displayed on the display unit 13. FIG. 5 shows an example where the plurality of change factors (contrast, noise amount, and size) is identified by the change factor identifying unit 22, in a similar manner to FIG. 4.

The input screen 42 includes the reference image 51 and the verification image 61 in a similar manner to the input screen 41.

Regarding each of the plurality of change factors, the input screen 42 includes index values 52A to 52C of each of the change factors regarding the reference image 51 and index values 62A to 62C of each of the change factors regarding the verification image 61. In the example of FIG. 5, the index values 62A to 62C regarding the verification image 61 are displayed as values indicating ratios when the index values 52A to 52C regarding the reference image 51 have a value of “1.00”. However, instead of the ratios, the value of each of the index values 52A to 52C and 62A to 62C may be displayed.

The input screen 42 includes the selection information input fields 71A to 71C and the numerical information input fields 81A to 81C in a similar manner to the input screen 41.

The contents input by the user into the selection information input fields 71A to 71C and the numerical information input fields 81A to 81C in the input screen 42 are input to the information processing unit 11 as the policy information indicating the policy set by the user for relearning, and are acquired by the policy information acquisition unit 24.

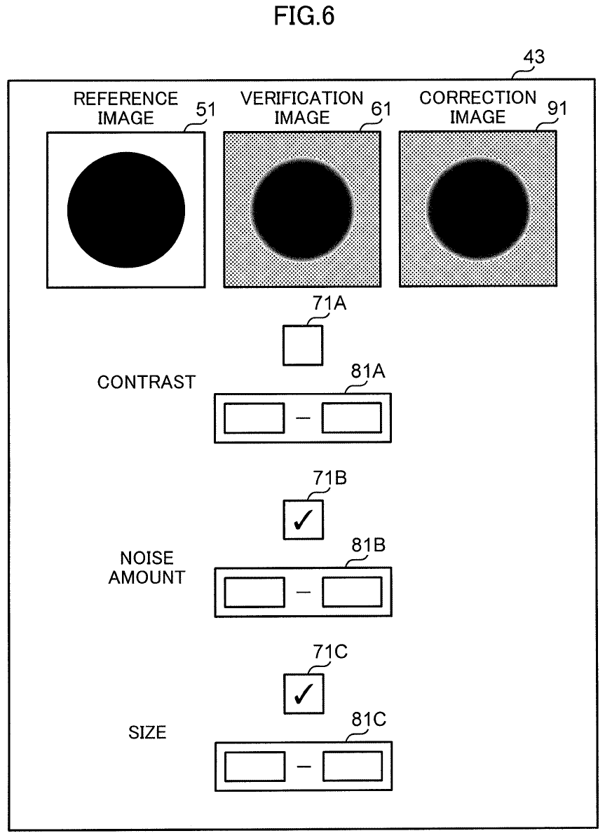

FIG. 6 is a diagram showing an input screen 43 as a third example of the explanatory information generated by the explanatory information generation unit 23. The input screen 43 is presented to the user by being displayed on the display unit 13. FIG. 6 shows an example where the plurality of change factors (contrast, noise amount, and size) is identified by the change factor identifying unit 22, in a similar manner to FIG. 4.

The input screen 43 includes the reference image 51 and the verification image 61 in a similar manner to the input screen 41.

The input screen 43 includes a correction image 91 in which the reference image 51 is multiplied by the value of each of the change factors to reflect the change form of the change factor on the reference image 51. Note that the correction image 91 may be an image that reflects the change form of the change factor on the verification image 61 by multiplying the verification image 61 by the inverse number of the value of the change factor to remove the influence of the change factor from the verification image 61. Instead of the correction image 91 or in addition to the correction image 91, a difference image between the reference image 51 and the verification image 61 may be included in the input screen 43.

The input screen 43 includes the selection information input fields 71A to 71C and the numerical information input fields 81A to 81C in a similar manner to the input screen 41.

The contents input by the user into the selection information input fields 71A to 71C and the numerical information input fields 81A to 81C in the input screen 43 are input to the information processing unit 11 as the policy information indicating the policy set by the user for relearning, and are acquired by the policy information acquisition unit 24.

According to the present embodiment, the explanatory information generation unit 23 presents the explanatory information indicating the change factor identified by the change factor identifying unit 22 to the user, and the relearning unit 25 performs relearning of the machine learning model 31 based on the policy information set by the user based on the explanatory information. In this way, the relearning is performed by exchanging the explanatory information and the policy information, rather than by the user's manual operation on an image-by-image basis, making it possible to efficiently assist relearning of the machine learning model by the user.

The present embodiment allows presentation of the explanatory information including the reference image 51 and the verification image 61 to the user, making it possible to more efficiently assist relearning of the machine learning model 31 by the user.

With the input screen 41 shown in FIG. 4, the explanatory information including the reference images 51A to 51C and the verification images 61A to 61C generated individually for each of the plurality of change factors can be presented to the user, and the user can easily understand the change form of the change factor, making it possible to more efficiently assist relearning of the machine learning model 31 by the user.

With the input screen 42 shown in FIG. 5, the explanatory information including the index values 52A to 52C and 62A to 62C of the change factors regarding each of the reference image 51 and the verification image 61 can be presented to the user, and the user can casily understand the change form of the change factors, making it possible to more efficiently assist relearning of the machine learning model 31 by the user.

With the input screen 43 shown in FIG. 6, the explanatory information including at least one of the correction image 91 and the difference image can be presented to the user, and the user can easily understand the change form of the change factors, making it possible to more efficiently assist relearning of the machine learning model 31 by the user.

According to the present embodiment, the user can set whether or not to include each of the plurality of change factors as a subject of relearning with contents input to the selection information input fields 71A to 71C, making it possible to more efficiently assist relearning of the machine learning model 31 by the user.

According to the present embodiment, the user can set the permissible range when performing relearning with contents input to the numerical information input fields 81A to 81C, making it possible to more efficiently assist relearning of the machine learning model 31 by the user.

According to the present embodiment, the change factor identifying unit 22 identifies the change factor based on an output value when the reference data set 32 is input to a learned model and an output value when the verification data set 33 is input to the learned model. This makes it possible to easily identify the change factor between the reference data set 32 and the verification data set 33. Even when changes in features that are difficult to quantify occur, such as texture or combinations of a plurality of features, using the learned model (for example, deep learning model that undergoes machine learning) makes it possible to identify the change factor between the reference data set 32 and the verification data set 33 by using higher-level features.

According to the present embodiment, using the machine learning model 31, which is a subject of relearning, as a learned model makes it possible to easily and accurately identify the change factor between the reference data set 32 and the verification data set 33.

According to the present embodiment, the reference data set 32 includes the learning image data used when performing learning of the machine learning model 31, and the verification data set 33 includes the verification image data that is incorrectly determined in inference using the machine learning model 31, making it possible to easily and accurately identify the change factor between the reference data set 32 and the verification data set 33.

According to the present embodiment, when the determination accuracy is improved by performing the image processing in the first direction on the verification image data, performing relearning using image data obtained by performing the image processing in the second direction opposite to the first direction on the learning image data makes it possible to improve the determination accuracy of the machine learning model 31 after the relearning.

### INDUSTRIAL APPLICABILITY

The present disclosure is useful when applied to the AI system using the machine learning model. In particular, it is possible to implement introduction of a plurality of AI systems to highly variable inspection processes or small-volume, wide-variety processes, where the introduction of AI systems has been difficult until now.

1. An information processing method for assisting relearning of a machine learning model, the method comprising:
by an information processing device,
identifying at least one change factor between a predetermined reference data set and a verification data set different from the reference data set based on the reference data set and the verification data set;
generating and outputting explanatory information for presenting the identified change factor to a user; and
performing the relearning of the machine learning model based on policy information indicating a policy for the relearning set by the user based on the explanatory information.

2. The information processing method according to claim 1, wherein the explanatory information includes a reference image representing a representative image obtained by visualizing the reference data set, and a verification image representing a representative image obtained by visualizing the verification data set.

3. The information processing method according to claim 2, wherein
the at least one change factor includes a plurality of the change factors, and
generating the explanatory information includes individually generating the reference image and the verification image for each of the plurality of change factors.

4. The information processing method according to claim 2, wherein the explanatory information further includes an index value of the change factor regarding the reference image and an index value of the change factor regarding the verification image.

5. The information processing method according to claim 2, wherein the explanatory information further includes at least one of a correction image that reflects a change form of the change factor in one of the reference image and the verification image, and a difference image between the reference image and the verification image.

6. The information processing method according to claim 1, wherein
the at least one change factor includes a plurality of the change factors, and
the policy information includes setting information set by the user regarding whether or not each of the plurality of change factors is to be a subject of the relearning.

7. The information processing method according to claim 6, wherein the policy information further includes setting information set by the user as to a permissible range during the relearning regarding the change factor that is a subject of the relearning.

8. The information processing method according to claim 1, wherein identifying the change factor includes identifying the change factor based on an output value when the reference data set is input to a predetermined learned model and an output value when the verification data set is input to the learned model.

9. The information processing method according to claim 8, wherein as the learned model, the machine learning model that is a subject of the relearning is used.

10. The information processing method according to claim 9, wherein
the reference data set includes learning image data used when learning the machine learning model, and
the verification data set includes verification image data that is incorrectly determined in inference using the learned machine learning model.

11. The information processing method according to claim 10, wherein
in identifying the change factor, when determination accuracy is improved by performing image processing in a first direction on the verification image data,
performing the relearning of the machine learning model includes performing the relearning by using image data obtained by performing image processing in a second direction opposite to the first direction on the learning image data.

12. An information processing device for assisting relearning of a machine learning model, the information processing device comprising:
an identifying unit that identifies at least one change factor between a predetermined reference data set and a verification data set different from the reference data set based on the reference data set and the verification data set;
a generation unit that generates and outputs explanatory information for presenting the change factor identified by the identifying unit to a user; and
a relearning unit that performs the relearning of the machine learning model based on policy information indicating a policy for the relearning set by the user based on the explanatory information.

13. A computer-readable non-transitory recording medium recording a program for causing an information processing device for assisting relearning of a machine learning model to perform a process comprising:
identifying at least one change factor between a predetermined reference data set and a verification data set different from the reference data set based on the reference data set and the verification data set;
generating and outputting explanatory information for presenting the change factor identified to a user; and
relearning of the machine learning model based on policy information indicating a policy for the relearning set by the user based on the explanatory information.
